(19) United States
(12) Patent Application Publication
(10) Pub. No.: US 2005/0198628 A1
(43) Pub. Date: Sep. 8, 2005

(54) Creating a platform specific software image

(76) Inventors: Christoph J. Graham, Houston, TX (US); Tri Minh Nguyen, Cypress, TX (US); William Whipple, Magnolia, TX (US); Gunnar Paul Seaburg, The Woodlands, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/793,602

(22) Filed: Mar. 4, 2004

(51) Int. Cl. G06F 9/445

(52) U.S. Cl. 717/174

(57) ABSTRACT

Systems, methodologies, media, and other embodiments associated with producing a platform specific software image are described. One exemplary system embodiment includes a data store configured to store a superset of building blocks from which the platform specific software image can be built. The example system may also include a build logic configured to selectively extract building blocks from the superset and to produce a platform specific software image based on information available about the target platform for which the software image is being made platform specific. The example system may also include an image creator for storing the platform specific software image on a computer-readable medium that is operably connectable to the target platform.

### BACKGROUND

Computer hardware components may be mass-produced in a set of factories. Then, the computer hardware components may be arranged into a platform (e.g., personal computer (PC)) at another factory. The platform may be a “standard platform” designed to satisfy a set of consumer requirements (e.g., office computer, gaming computer) or may be “custom-built” to meet specific user requirements. In either case, at some point software will be loaded onto the platform and/or one of its components (e.g., hard disk drive).

One method for loading software onto a platform is for a consumer to install it. However, with the increasing variety of hardware components, the complexity of those hardware components, and the increasing number of configurations into which they may be configured to form a platform, having a consumer install software, particularly system software like operating system components (e.g., device drivers) may not produce desired results. For example, getting a workable combination of software components like operating systems, applications, device drivers, file system components, data structures, and so on may be difficult, causing the installed software to not function properly.

Another method for loading software is to have a worker at a factory install it. Hand-crafting a software image onto a platform by installing software suited to the hardware, its destination, its potential use, and so on may include an engineer performing manual activities involving disparate tools that acquire data from a variety of locations using a variety of methods. The manual activities (e.g., data entry) may be prone to typographic errors, syntax errors, omissions, and the like. Additionally, there may be no cohesion between the manual activities, and thus steps may be omitted, performed in the wrong order, be difficult to recreate, be difficult to document (e.g., for training purposes), be difficult to perform quality assurance for, and so on. Furthermore, installing software on a large volume of platforms in a timely manner may be labor intensive and produce non-standard implementations based, for example, on differences between installers.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

Prior Art FIG. 1 illustrates an example system that produces individual software images for individual platforms.

FIG. 2 illustrates an example system for installing onto a target platform a platform specific software image built from building blocks stored in a superset of building blocks.

FIG. 3 illustrates another example system for installing onto a target platform a platform specific software image built from building blocks stored in a superset of building blocks.

FIG. 4 illustrates an example method for building a platform specific software image.

FIG. 5 illustrates an example method for producing a platform specific software image from a superset of building blocks and installing the platform specific software image onto a computer-readable medium associated with a target platform.

FIG. 6 illustrates an example computing environment in which example systems and methods illustrated herein can operate.

FIG. 7 illustrates an example application programming interface (API).

FIG. 8 illustrates an example method associated with a graphical user interface (GUI).

### DETAILED DESCRIPTION

An organization (e.g., software manufacturer, software provider) may have an inventory of hundreds or thousands of software components and/or data components from which a software image can be built for a platform. As used herein, the term “software image” refers to a set of processor readable data and a set of processor executable instructions that are logically combined into a single logical entity. The logical entity may include a set of physical components like databases, data files, records, tables, executable programs, source code, objects, dynamic link libraries, and the like. The logical entity may also include, for example, rules for combining, processing, initiating and so on the physical components. The example systems and methods described herein facilitate automatically building a software image from the available components and installing the software image on a target platform for which platform identifying information is available. The software components and/or data components may be referred to as “building blocks”, since a software image may be constructed from these smaller parts. The building blocks, and data associated with the building blocks can be gathered into a data store like a database or set of databases. Then, an automated process(es) can pick and choose appropriate building blocks for building the platform specific software image based on information like hardware components in the target platform, a region in which the target platform will be used, a type of application for which the platform will be used, interactions between various building blocks, and so on. The process(es) may then perform processing (e.g., compiling, linking, translating, linking, copying) to prepare the building blocks to be formed into the platform specific software image and then install the platform specific image on the target platform.

To facilitate building a software image an organization may locate, organize, produce, index, and so on, the building blocks from which a software image can be built. This collection of building blocks may be referred to as a “superset” of building blocks. The organization may also locate, organize, produce, index, and so on rules concerning how to process the building blocks. These rules may be added to the superset. Then, a software image can be produced from the superset by selecting a subset of the building blocks and/or rules, selectively processing (e.g., compiling, linking) the selected subset of building blocks according to the rules as affected by the platform information, and storing the platform specific software image on a computer-readable medium.

In one example, an automated build process and/or apparatus may acquire content (e.g., building blocks) for an image, acquire attributes about the content for the image, acquire constraint information concerning building the image, and then control a disk writer to store onto a target platform and/or one of its components the image constructed from the content and the rules.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Query”, as used herein, refers to a semantic construction that facilitates gathering and processing information. A query might be formulated in a database query language like structured query language (SQL) or object query language (OQL). A query might be implemented in computer code (e.g., C#, C++, Javascript) that can be employed to gather information from various data stores and/or information sources.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

Prior Art FIG. 1 illustrates a system 100 that may have produced individual software images for individual platforms. The system 100 may have included a set of data stores (e.g., 110, and 112 through 118) in which various software building blocks were stored. Conventionally, multiple copies of a building block may have been replicated in multiple data stores. An organization may have maintained the multiple data stores 110 through 118 to support installing software images on various target platforms in various factories. Selected building blocks may have been combined by various processes (e.g., 120, and 122 through 128) into individual software images (e.g., 130, and 132 through 138) unique to individual platforms (e.g., 140, and 142 through 148). The processes 120 through 128 may have included a combination of computer programs and manual processes. Producing the images 130 through 138 may have involved gathering some information about the target platforms 140 through 148, searching through the data stores 110 through 118 for building blocks, applying experience to determine how to process (e.g., prepare, combine) selected building blocks, processing the selected building blocks into software images and storing the images on various platforms.

Using the multiple data stores and processes illustrated in system 100, a set of software images may have been created and stored in a set of data stores unique to creating that type of software image. In a manufacturing environment, this might be referred to as a multiple-SKU (stock keeping unit) approach. The term SKU generally refers to a number associated with a product for inventory purposes, although the actual product may sometimes be referred to as an SKU. The multiple-SKU approach may cause an organization tasked with installing software onto platforms to maintain a substantial catalog of software images since it may not be possible to create an image on demand depending on the availability of the data stores and/or the personnel for accessing the data stores and constructing an image. Additionally, the multiple-SKU approach may lead to multiple substantially similar products being produced and inventoried for substantially similar target platforms. Since various processes 120 through 128 may produce these products, software images produced for substantially similar target platforms may be different rather than desirably similar. Furthermore, since a variety of processes may be employed, building blocks taken from a variety of data stores, and building blocks configured ad hoc into a software image, a particular software image that is produced may be difficult to recreate.

The multiple-SKU approach is one approach to building a software image. However, the example systems and methods described herein provide a different approach for hardware manufacturers, software installers, and so on who face the situation where hardware components get built and assembled into a platform onto which it is desired to put software. Rather than maintaining a large number of data stores, processes, and personal experience to build software images, as was customary in the multiple-SKU approach, a single-SKU approach can be taken.

The single-SKU approach may also be referred to as the super-SKU or superset approach. In the single-SKU approach, building blocks, rules concerning building blocks, data about building blocks, and other data and/or processes concerning building a software image from selected building blocks may be gathered onto a single computer-readable medium (e.g., data store, database) that facilitates producing, on-demand, a custom image for a target platform as information about the platform is provided. It is to be appreciated that the computer-readable medium may be a logical repository implemented by a collection of physical data stores like a distributed database accessible via a computer network. In one example, information about the target platform may facilitate generating a query to a database in which building blocks are stored. Building blocks, data, processes, and so on retrieved form the database can then be employed to automatically produce a software image specific to the target platform for which the information was provided. Thus, manual processes are decreased, automated processes are increased, the inventory of SKUs is reduced, and the repeatability of producing a software image is increased. In one example, the single-SKU may be associated with a tree based data structure that facilitates segregating software components into related branches while maintaining a single copy of a software component.

Example systems and methods may combine hardware discovery techniques like those associated with software restoration and software management techniques like those associated with software installation. Then the hardware discovery techniques and software management techniques may interact with process and state management capabilities found in file based installation systems and methods.

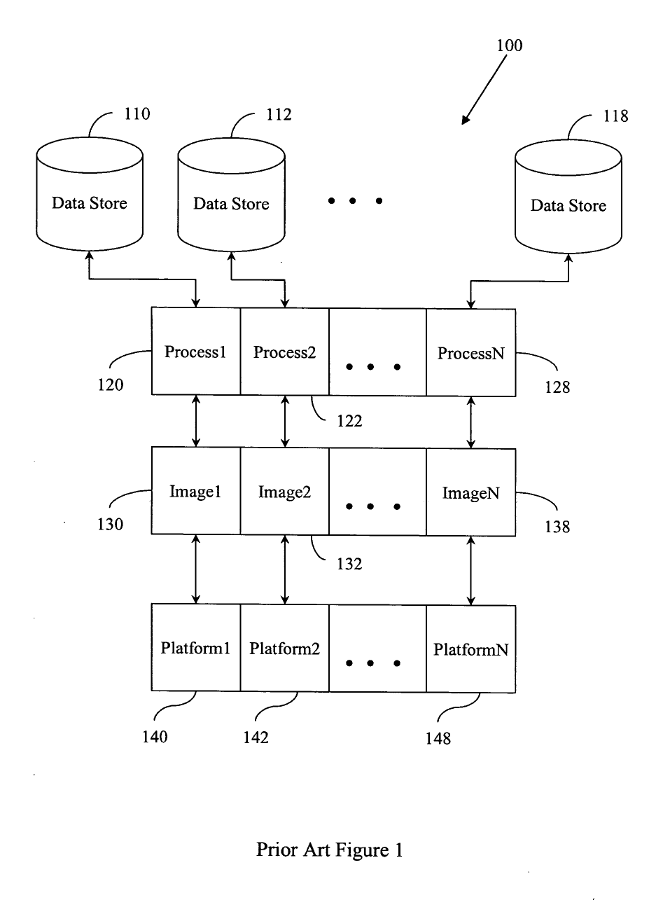

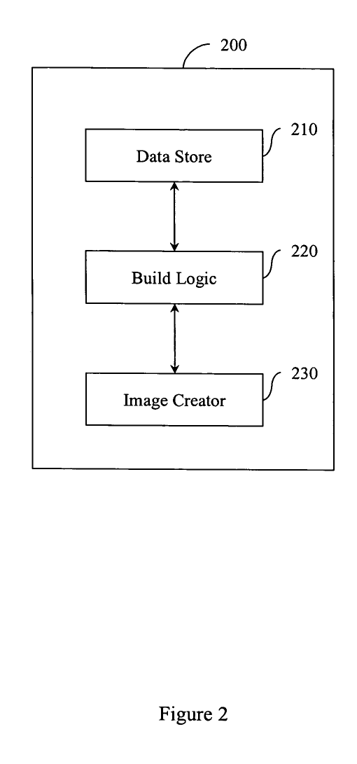

FIG. 2 illustrates an example system 200 for automatically building a platform specific software image from building blocks stored in a building block superset. The system 200 may also facilitate installing the platform specific software image on a target platform for which identifying information was provided and to which the software image was made platform specific. The system 200 may include a data store 210 that is configured to store a set of building blocks, data associated with building blocks that are members of the set of building blocks, and/or the set of building blocks. A building block may be, for example, a file, a program, an application, an object, a dynamic link library, a data structure definition, a data structure, a file system definition, a file system, an applet, a servlet, a subroutine, a database record, a database, a device driver, an operating system service pack, a quick fix engineering component (e.g., bug fix), and the like. The software image may be built partially and/or completely from a subset of the building blocks stored in the set of building blocks. The data store 210 may also store data concerning building blocks in the set of building blocks. The data may be build information like rules, heuristics, programs, build lists, build definitions, dependencies, executables, and the like. Build information may facilitate controlling how building blocks are processed into the software image.

The system 200 may also include a build logic 220 that is operably connectable to the data store 210. The build logic 220 may be configured to selectively read build information and, in response to analyzing build information, to selectively read a subset of building blocks from the data store 210. For example, build information may indicate that a certain subset of building blocks are required to build a software image for a platform with a certain set of hardware components that is going to be used for a certain application in a certain region. Thus, based on build information, that subset of building blocks may be read from the data store 210. By way of illustration, a first target platform may include a first mix of hardware components and be intended for use as a gaming platform in Canada. Based on this information and/or other build information in the data store 210, the build logic 220 may select a first subset of building blocks and process them in a first way to build a custom software image for the first target platform. By way of further illustration, a second target platform may include a second mix of hardware components and be intended for use as a business computer in New York City. Based on this information and/or other build information in the data store 210, the build logic 220 may select a second subset of building blocks and process them in a second way to build a custom software image for the second target platform. Unlike the conventional system 100 (illustrated in FIG. 1) that reads from multiple locations and uses multiple processes (some manual) to produce a variety of images, the build logic 220 may be configured to read building blocks and/or build information from a single superset of building blocks and related data that is stored in the data store 210. The build logic 220 may also be configured to automatically produce the software image using a single build process.

Build information may be stored as attributes. These attributes may describe, for example, information concerning an operating system associated with a building block, an operating system version associated with a building block, a spoken language associated with a building block, a computer language associated with a building block, a region in which a building block functions, a device identifier for a device with which a building block may function, a release data associated with a building block, an architecture with which a building block functions, and the like. Thus, the attributes may also facilitate controlling how the building blocks are processed into the software image. In one example, where the superset is stored in a database, information about the target platform may facilitate generating a query to the database in which the building blocks are stored. The database may be stored in the data store 210. The query based on the information about the target platform may be matched against attributes stored in the data store 210 to facilitate retrieving a desired subset of building blocks.

In one example, the system 200 includes an image creator 230 configured to store the software image on a computer-readable medium like a hard disk drive in the target platform. Thus, the build logic 220 may be further configured to control the image creator 230 to store the software image on the computer-readable medium. Controlling the image creator 230 may include, for example, sending a signal to the image creator 230 to write the software image to the computer-readable medium. The image creator 230 may be configured to store the software image on a computer-readable medium like a compact disc (CD), a digital versatile disk (DVD), a tape, a floppy disk, a Zip disk, an application specific integrated circuit, a memory stick, a memory, a USB token, and so on.

In one example, a software image includes content elements that are derived from building blocks. For example, deriving a content element from a building block may include simply copying the building block or taking more complicated actions like, compiling the building block to produce an executable, interpreting the building block to produce an executable, assembling the building block to produce an executable, translating the building block, and the like. Since a content element may be derived from a building block, a content element may be, for example, a file, a program, an application, an object, a dynamic link library, a data structure definition, a data structure, a file system definition, a file system, an applet, a servlet, a subroutine, a database record, and a database. In addition to content elements, a software image may include rules for combining content elements, a program(s) for initiating content elements on a target platform, a program(s) for combining content elements into portions of a software image, computer executable instructions for analyzing (“touching”) the target platform to discover hardware, software, and/or firmware configurations at boot time, and the like. Thus, it is to be appreciated that in one example the software image prepared for the target platform may subsequently be processed on the target platform.

In one example, the build logic 220 is configured to store, in the data store 210, information about building the software image and/or information about storing the software image on the target platform. Thus, information may be fed back from the image creator 230 to the build logic 220. This information may describe how long it took to build the computer-readable medium, whether the build was successful, the size of the software image, and the like.

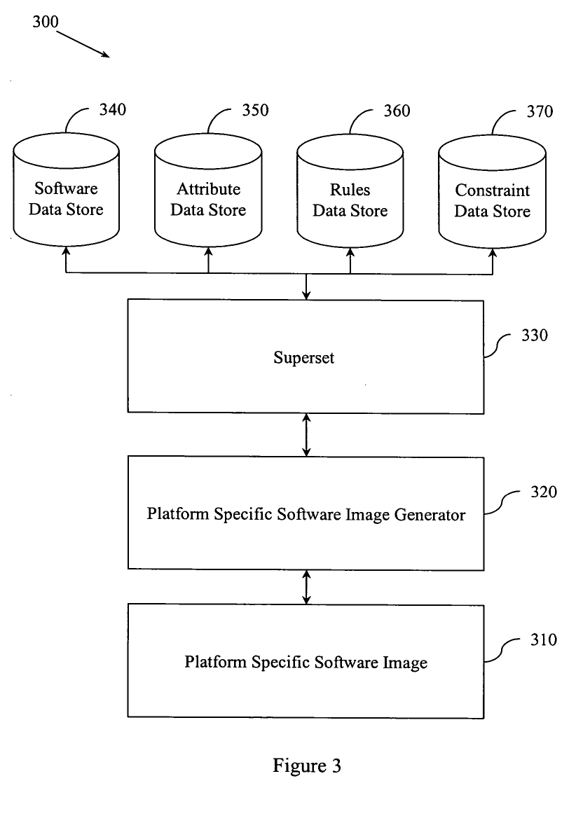

FIG. 3 illustrates an example system 300 for automatically building a platform specific software image 310. One example system 300 includes a platform specific software image generator 320 that retrieves information from a superset 330 of building blocks, and then produces the platform specific software image 310. In one example, the platform specific software image generator 320 also controls a computer-readable medium creator (not illustrated) that stores the platform specific software image 310 onto a computer-readable medium that is operably connectable to a target platform for which the software image has been made platform specific.

The example system 300 may have referenced a software data store(s) 340 from which building blocks for building a software image can be retrieved, retrieved a building block and stored it in the superset 330. A building block may be, for example, a file, a program, an application, an object, a dynamic link library, a data structure definition, a data structure, a file system definition, a file system, an applet, a servlet, a subroutine, a database record, a database, and the like.

The system 300 may also have referenced an attribute data store(s) 350 from which data concerning building blocks can be retrieved, retrieved attribute data and stored it in the superset 330. Attributes can include, for example, build lists, known interactions between building blocks, desired interactions between building blocks, dependencies between building blocks, and the like. Attributes may also store information like an operating system associated with a building block, an operating system version associated with a building block, a spoken language associated with a building block, a computer language associated with a building block, a geographic region in which a building block may function, a device identifier for a device with which a building block may function, a release data associated with a building block, an architecture with which a building block may function, a build list, an interaction between two or more building blocks, a desired interaction between two or more building blocks, and a dependency between two or more building blocks. By way of illustration, there may be four building blocks available to support converting a first data format to a second data format. A first operating system may process both data formats, but a second operating system may process neither data format. Thus, an attribute associated with a building block may identify operating systems for which the building block is required and operating systems to which the building block is substantially useless. If the build logic 310 has information concerning the operating system for the target platform, then the attribute may be used to selectively read a desired building block(s) from the superset 330 to facilitate producing the software image that will work with the operating system.

The system 300 may also have referenced a rules data store(s) 360 from which rules concerning how various building blocks may be combined can be retrieved. The system 300 may have retrieved a rule and stored it in the superset 330. A rule may be implemented, for example, as computer executable instructions and/or data. A rule may facilitate controlling, for example, whether a building block is included in a software image, how to process (e.g., compile, link, interpret) a building block, deciding how to combine building blocks (e.g., order, connections, dependencies), and so on. A rule may also facilitate determining how to limit a building block in a software image. For example, a rule may determine that if a first operating system is present in the software image then a first building block may be employed in building a software image but if a second operating system is present, then a second building block may be employed instead of the first building block. A rule may be employed to control what the software image does after the software image is associated with (e.g., boots) the target platform. A rule may control the order in which building blocks are installed and combined, may control how building blocks are connected, and so on. A rule may be compiled from conventional/historic build definitions that may include handwritten notes, computer programs, scripts, personal knowledge, and so on. Thus, a rule may describe how a building block is to be selected for inclusion in a software image, how to combine two or more building blocks, how to connect two or more building blocks, when a building block is to be processed, how a building block is to be processed, and so on. A rule may describe a dependency between a hardware component and a software component, a dependency between two or more software components, undesirable combinations of software components, and so on.

The example system 300 may also have referenced a constraint data store(s) 370 from which constraints concerning the scope of coverage for a software image and/or when to exclude a building block from a software image may be retrieved, retrieved constraints and then stored them in the superset 330. A constraint may facilitate establishing a scope of the software image. A constraint may be applied when building the platform specific software image 310. For example, a constraint may describe how a first block (e.g., RSA encryption block) is to be employed inside the continental United States while a second block (e.g., PGP encryption block) is to be employed outside the continental United States to comply with federal regulations concerning exporting encryption algorithms.

While four separate data stores are illustrated, it is to be appreciated that the four data stores could be distributed between a greater number of data stores and/or collected in a smaller number of data stores. The four separate data stores may be the separate data stores from which conventional systems may have individually built images. Referencing the data stores and collecting information into the superset 330 facilitates performing automated processes like those performed by the platform specific software image generator 320.

The system 300 may also include a platform specific software image generator 320 that is configured to read building blocks, attributes, rules, and/or constraints from the superset 330. After acquiring this set of data, the platform specific software image generator 320 may build a platform specific software image 310 by selecting, processing, and combining various building blocks according to various rules, attributes, and constraints. How the platform specific software image generator 320 processes the building blocks into the platform specific software image 310 may be controlled, at least in part, by rules and/or constraints. The platform specific software image generator 320 may, for example, have building blocks copied to the platform specific software image 310, have building blocks compiled into executables and then copied to the platform specific software image 310, have building blocks compressed and/or decompressed and then copied to the platform specific software image 310, and so on. The platform specific image generator 320 may be implemented, for example, as a logic.

In one example, the system 300 may include a media creator (not illustrated) that is configured to store the platform specific software image 310 on a computer-readable medium. The media creator may be configured to store the platform specific software image 310 on computer-readable mediums like a hard disk drive, a compact disk (CD), a digital versatile disk (DVD), a tape, a floppy disk, a Zip disk, an application specific integrated circuit, a memory stick, a memory, a Universal Serial Bus (USB) token, and the like. The computer-readable medium may or may not already be incorporated into, associated with, and/or operably connected to the target platform at the time the platform specific software image 310 is stored on the computer-readable medium.

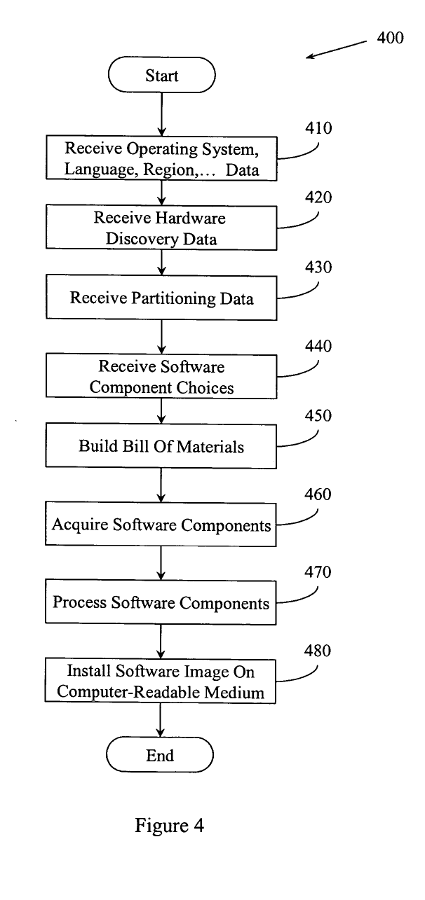

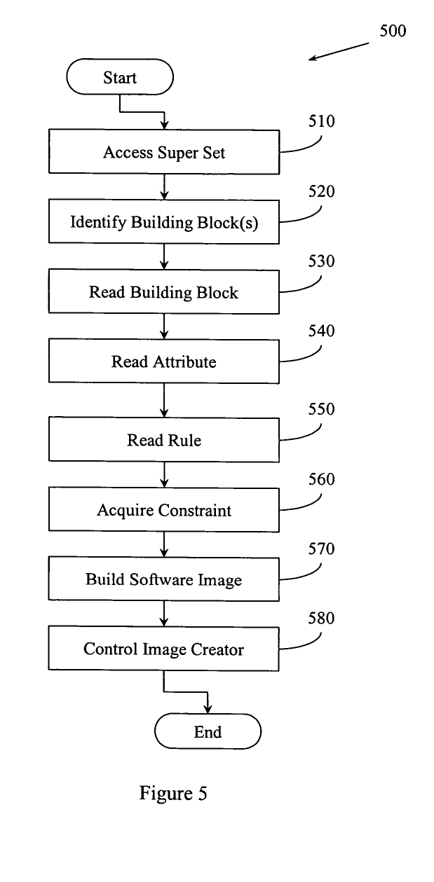

Example methods may be better appreciated with reference to the flow diagrams of FIGS. 4 and 5. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 4 illustrates a method 400 for building a platform specific software image and storing it on a computer-readable medium. The method 400 assumes that a superset like that described above in connection with FIG. 3 is available. Method 400 may pre-determine a software load for a target platform through, for example, rules governing the appropriate software bill of materials for a given hardware configuration associated with the target platform and how the platform will be employed in a given field in a given region of the world.

Thus, method 400 may include, at 410, receiving data that identifies, for example, the operating system(s) to be employed on the target platform, language(s) spoken by a target platform user, data that identifies the region of the world in which the target platform will be used, data that identifies a target platform usage (e.g., business, gaming), and the like. The data facilitates producing a query and/or a filter that in turn facilitate retrieving an appropriate subset of building blocks from the superset. For example, the superset may have an English language version of a file and a Spanish language version of a file. If the data indicates that the target platform will be used by a Spanish speaking individual for business in Madrid, then the Spanish language version of the file may be retrieved and prepared for the platform specific software image.

The method 400 may also include, at 420, receiving hardware discovery data. The hardware discovery data may be received from a process that interrogates, analyzes, and/or investigates the target platform and/or data concerning the target platform to discover which hardware, firmware, and/or software components are and/or will be included in the target platform. The hardware discovery data may identify hardware components in the target platform, connections between the hardware components, software installed on the target platform, firmware installed on the target platform, and the like. The hardware discovery data facilitates producing a query and/or filter that in turn facilitate retrieving, for example, an appropriate device driver from the superset. For example, if a target platform includes a read/write DVD, then an appropriate device driver may be retrieved from the superset to support that read/write DVD hardware device.

The method 400 may also include, at 430, receiving data concerning a computer-readable medium partitioning choice. A computer-readable medium like a hard disk drive may be logically divided into various partitions. Thus a target platform may have multiple platform specific software images prepared for it. For example, a target platform may include a hard disk drive that is partitioned into a Windows XP partition and a UNIX SVR4 partition. The user may desire to have software pre-installed into one or both of these partitions. Thus, the method 400 may acquire data concerning these partitions to facilitate retrieving appropriate building blocks and building them into an appropriate software image. It is to be appreciated that some target platforms will include a computer-readable medium with only one partition while other target platforms may include multiple partitions.

The method 400 may also include, at 440, receiving software component choices. For example, a first user may desire that a certain word processor, spreadsheet, graphing program and Internet browser be installed on their target platform while a second user may desire that a different word processor, no spreadsheet, a music composing application, and a different Internet browser be installed on their target platform. These choices may be indicated in the software component choices. Thus, receiving the software component choices facilitates retrieving an appropriate subset of building blocks from the superset and fashioning them into a platform specific software image. It is to be appreciated that some target platforms will not have custom software choices made for them and thus may be configured as “standard” or “stock” platforms. In this case, the software component choices may be retrieved, for example, from a default configuration file in the superset.

With the data gathered from 410 through 440 above, the method 400 may then, at 460, build a software bill of materials based, at least in part, on the received data. While a bill of materials is described, it is to be appreciated that building blocks may be retrieved on the fly as sufficient information is received thus removing the additional action, at 450, of compiling a bill of materials that specifies building blocks to be included in a platform specific software image.

Having built the software bill of materials, the method 400 may proceed, at 460, to acquire the subset of building blocks listed in the bill of materials using a query that is based, at least in part, on the received data. The query can be presented to a database that stores the superset of building blocks. While a single query is described, it is to be appreciated that the data acquired from 410 through 440 may be included in one or more queries to retrieve one or more building blocks from the superset.

After acquiring a member of the subset of building blocks, the method 400 may include, at 470, processing the member. Processing building blocks may include copying a building block, compiling it, assembling it, translating it, interpreting it, populating a data structure included in the building block, and so on. In some cases a building block may be used “as-is” and thus no action beyond copying, and/or recording that a building block was retrieved may be undertaken at 470.

Having acquired and/or processed the subset of building blocks for the platform specific software image whose target platform was described, at least in part, by the attributes collected from 410 through 440, the method 400 may then, at 480, produce the software image and cause it to be written to a computer-readable medium like a hard disk drive associated with the target platform. In one example, the hard disk drive may already be installed in the target platform while in another example the hard disk drive or other computer-readable medium may be configured with the platform specific software image and then subsequently associated with (e.g., installed in) the target platform. For example, a target platform may not boot from a hard drive but may include a connector by which a boot memory may be operably connected. In this example, the platform specific software image may be written to a memory stick, a memory card, a USB token, and the like, which can then serve as the boot device for the target platform.

While FIG. 4 illustrates various actions occurring in serial, it is to be appreciated that various actions illustrated in FIG. 4 could occur substantially in parallel. By way of illustration, a first process could acquire attributes like operating system data, hardware discovery data, partition data, software choices and so on. Similarly, a second process could build a bill of materials, while a third process could produce queries for retrieving building blocks. A fourth process could retrieve building blocks, a fifth process could process the building blocks into a software image and a sixth process could write the image to a computer-readable medium. While six processes are described, it is to be appreciated that a greater and/or lesser number of processes could be employed and that lightweight processes, regular processes, threads, and other approaches could be employed.

FIG. 5 illustrates an example method 500 for producing a platform specific software image from a superset of building blocks and installing the platform specific software image onto a computer-readable medium associated with a target platform for which the software image has been made platform specific. The method 500 may include, at 510, accessing a superset in which building blocks, data concerning building blocks, rules, attributes, and so on are stored. Accessing the superset may include, for example, establishing a logical and/or physical connection with a data store in which the superset is stored. For example, accessing the superset may include logging into a database, making a connection over the Internet, and so on.

The method 500 may also include, at 520, identifying a building block(s) to be included in a software image to be built from the building blocks located in the superset. The building block(s) may be identified by examining information like, target platform parameters (e.g., operating system, hardware components), marketing concerns, security concerns, media storage capacity, and so on. The information may be available electronically and/or may by provided by a user interacting with a user interface.

The method 500 may also include, at 530, selectively reading, from the superset, the building blocks that were identified at 520. Which building blocks are read may be controlled, at least in part, by attributes associated with the software image and/or the target platform. For example, a more complicated software image and target platform may lead to more building blocks being read while a less complicated image and platform may lead to less building blocks being read. A building block may include, for example, a file, a program, an application, an object, a dynamic link library, a data structure definition, a data structure, a file system definition, a file system, an applet, a servlet, a subroutine, a database record, a database, and the like.

After building blocks have been read, the method 500 may seek to acquire more information about them. Thus, the method 500 may include, at 540, reading, from the superset, attributes concerning building blocks. The attributes may describe, for example, an operating system associated with a building block, an operating system version associated with a building block, a spoken language associated with a building block, a computer language associated with a building block, a geographic region in which a building block may function, a set of device identifiers for devices with which a building block may function, a release data associated with a building block, an architecture with which a building block may function, a build list, an interaction between two or more building blocks, a desired interaction between two or more building blocks, a dependency between two or more building blocks, and so on. Having acquired some information about the building block the method 500 may still seek more information about the building block and/or a software image to be built from the building blocks.

Thus, the method 500 may include, at 550, reading from the superset a rule concerning issues like how to process a building block into the software image. For example, a rule may describe how a building block is to be selected for inclusion in a software image, how to combine two or more building blocks, how to connect two or more building blocks, when a building block is to be processed, how a building block is to be processed, and the like.

The method 500 may also include, at 560, acquiring a constraint. The constraint may describe, for example, how a building block is to be limited in a software image built on a target platform, and so on. The constraint may be acquired from a human operator (e.g., software engineer), a process (e.g., artificial intelligence monitor), read from a data store (e.g., file), read from the superset and so on.

With the information concerning building blocks and how to process them collected, the method 500 may include, at 570, building a software image. The software image may include, for example, building blocks, components derived from building blocks, computer executable instructions for building a software image, computer-readable data for building a software image, and so on. Therefore, building the software image may include copying building blocks to the software image, compiling building blocks into object code and storing the object code in the software image, establishing logical and/or physical connections between building blocks, and so on. The method 500 may also include, at 580, controlling an image creator to store the software image on a computer-readable medium. For example, the method 500 may send a data packet describing the location of the software image, a desired build time, and other information to the image creator. Then, the method 500 may receive, (not illustrated), from the computer-readable image creator, a signal and/or a tracking data concerning how and/or whether the software image was stored on the computer-readable medium.

While FIG. 5 illustrates various actions occurring in serial, it is to be appreciated that various actions illustrated in FIG. 5 could occur substantially in parallel. By way of illustration, a first process could access the superset and identify building blocks to be retrieved, a second process could read building blocks, attributes, and rules, a third process could acquire constraints, a fourth process could build the software image, and a fifth process could control the image creator to store the software image on a computer-readable medium. While five processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method that includes accessing a data store configured to store a superset of software image building blocks, where a building block may be, for example, a file, a program, an application, an object, and the like. The method may also include identifying building blocks to be included in a software image and selectively reading a building block from the superset. The method may also include reading an attribute concerning the building block from the superset, where an attribute is configured to store information concerning, an operating system associated with a building block, an operating system version associated with a building block, a spoken language associated with a building block, a computer language associated with a building block, and the like. The method may also include reading a rule concerning how to process the building block into the software image from the superset, where a rule describes actions like how a building block is to be selected for inclusion in a software image, how to combine two or more building blocks, how to connect two or more building blocks, when a building block is to be processed, how a building block is to be processed, and so on. The method may also include acquiring a constraint concerning how the building block is to be limited in the software image, where a constraint describes actions like how to limit the operation of a building block, when to exclude a building block from a software image, and so on. The method may also include building a platform specific software image from building blocks and controlling an image creator to store the platform specific software image on a computer-readable medium associated with the target platform for which the software image was made platform specific.

While the above method is described being stored on a computer-readable medium, it is to be appreciated that other example methods described herein can also be stored on a computer-readable medium.

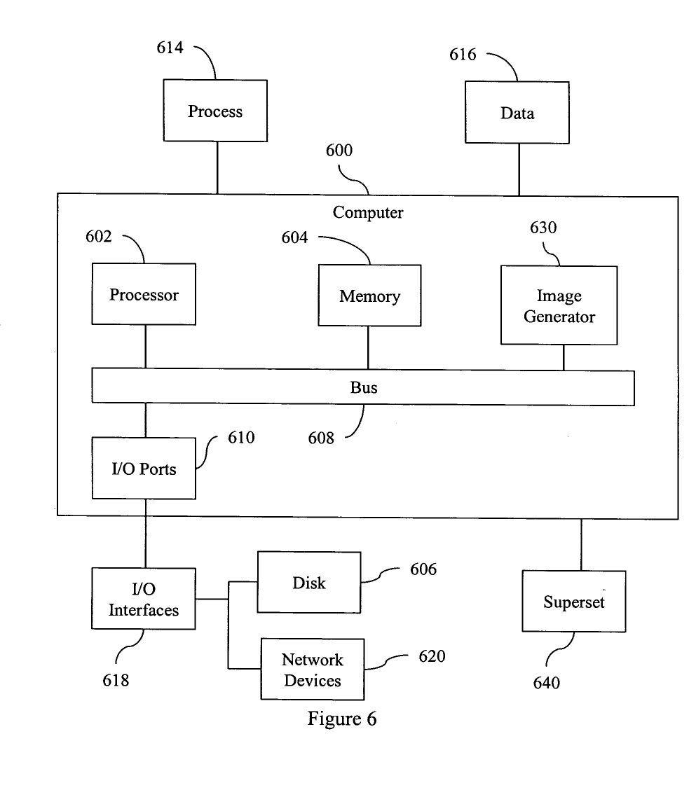

FIG. 6 illustrates a computer 600 that includes a processor 602, a memory 604, and input/output ports 610 operably connected by a bus 608. In one example, the computer 600 may include a platform specific software image generator 630 configured to facilitate producing a platform specific software image from a superset 640 of building blocks.

The processor 602 can be a variety of various processors including dual microprocessor and other multi-processor architectures. The memory 604 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 can include, but is not limited to, devices like a magnetic disk drive, a solid state disk drive, a floppy disk drive, a tape drive, a Zip drive, a flash memory card, and/or a memory stick. Furthermore, the disk 606 can include optical drives like a CD-ROM, a CD recordable drive (CD-R drive), a CD rewriteable drive (CD-RW drive), and/or a digital video ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus or mesh architectures. While a single bus is illustrated, it is to be appreciated that computer 600 may communicate with various devices, logics, and peripherals using other busses that are not illustrated (e.g., PCIE, SATA, Infiniband, 1394, USB, Ethernet). The bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and the like. The input/output ports 610 can include but are not limited to, serial ports, parallel ports, and USB ports.

The computer 600 can operate in a network environment and thus may be connected to network devices 620 via the i/o devices 618, and/or the i/o ports 610. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network devices 620 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 620 can connect to WAN technologies including, but not limited to, point to point links, circuit switching networks like integrated services digital networks (ISDN), packet switching networks, and digital subscriber lines (DSL).

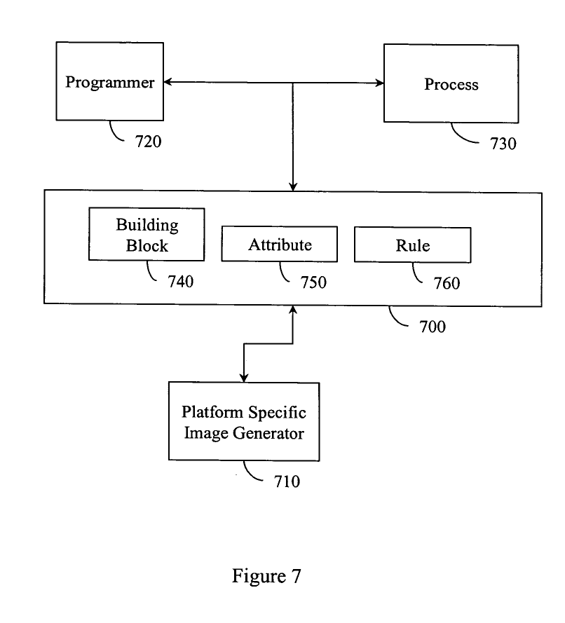

Referring now to FIG. 7, an application programming interface (API) 700 is illustrated providing access to a system 710 for producing a platform specific software image for a target platform based, at least in part, on information available concerning the target platform. The API 700 can be employed, for example, by a programmer 720 and/or a process 730 to gain access to processing performed by the system 710. For example, a programmer 720 can write a program to access the system 710 (e.g., invoke its operation, monitor its operation, control its operation), where writing the program is facilitated by the presence of the API 700. Rather than programmer 720 having to understand the internals of the system 710, the programmer 720 merely has to learn the interface to the system 710. This facilitates encapsulating the functionality of the system 710 while exposing that functionality.

Similarly, the API 700 can be employed to provide data values to the system 710 and/or retrieve data values from the system 710. For example, a process 730 that retrieves building blocks can provide a building block to the system 710 via the API 700 by, for example, using a call provided in the API 700. Thus, in one example of the API 700, a set of application programming interfaces can be stored on a computer-readable medium. The interfaces can be employed by a programmer, computer component, logic, and so on to gain access to a system 710 for producing a platform specific software image from a superset of building blocks. The interfaces can include, but are not limited to, a first interface 740 that communicates a building block, a second interface 750 that communicates an attribute concerning a building block, and a third interface 760 that communicates a rule concerning how a building block may be processed into the platform specific software image.

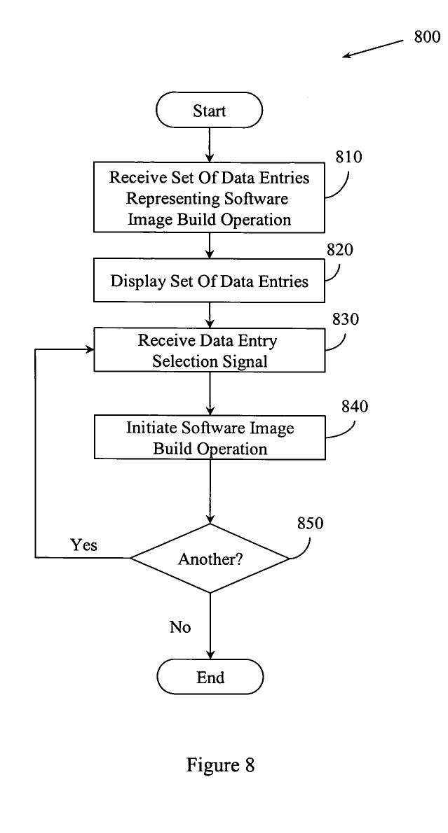

FIG. 8 illustrates an example method 800 associated with software image build operations and a graphical user interface. The method 800 may be performed in a computer system having a graphical user interface that includes a display and a selection device. The method 800 may include providing and selecting from a set of data entries on the display. Thus, in one example, the method 800 may include, at 810, retrieving a set of data entries, where a data entry represents a software image build operation like reading build information, reading building blocks, storing a software image on a computer-readable medium, and the like. The method 800 may also include, at 820, displaying the set of data entries on the display and, at 830, receiving a data entry selection signal indicative of the selection device selecting a selected data entry. The data entry selection signal may be received in response to, for example, a mouse click, a key press, a voice command, and so on. At 840, in response to the data entry selection signal, the method 800 may include initiating a software image build operation associated with the selected data entry. In one example, a determination is made at 850 concerning whether another data entry selection signal is to be processed. If the determination is Yes, then processing returns to 830, otherwise, method 800 may complete.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A system, comprising:
a data store configured to store a set of building blocks from which a platform specific software image can be built and a build information concerning members of the set of building blocks; and
a build logic operably connectable to the data store, the build logic being configured to selectively read the build information and, in response to analyzing the build information, to selectively read a subset of building blocks from the data store and to create the platform specific software image from the subset of building blocks based, at least in part, on build information and information concerning a target platform for which the software image is being made platform specific.

2. The system of claim 1, including an image creator configured to store the platform specific software image on a computer-readable medium, and where the build logic is further configured to control the image creator to store the platform specific software image on the computer-readable medium.

3. The system of claim 2, where the computer-readable medium is operably connected to the target platform at the time the platform specific software image is stored on the computer-readable medium.

4. The system of claim 2, where the computer-readable medium is not operably connected to the target platform at the time the platform specific software image is stored on the computer-readable medium.

5. The system of claim 1, where a building block comprises one or more of, a file, a program, an application, an object, a dynamic link library, a data structure definition, a data structure, a file system definition, a file system, an applet, a servlet, a subroutine, a database record, and a database.

6. The system of claim 1, where the build information includes one or more of, a rule, a heuristic, a program, a build list, a build definition, a dependency, and an executable, and where the build information is configured to control one or more of, whether to read a building block, how to process a building block, how to connect two or more building blocks, and how to combine two or more building blocks.

7. The system of claim 2, the image creator being configured to store the platform specific software image on one or more of, a hard disk drive, a compact disk (CD), a digital video disk (DVD), a tape, a floppy disk, a Zip disk, an application specific integrated circuit, a memory stick, a memory, and a Universal Serial Bus (USB) token.

8. The system of claim 2, where the platform specific software image includes a content element derived from a building block, where deriving the content element from the building block includes one or more of, copying, compiling, interpreting, assembling, and translating the building block.

9. The system of claim 8, where the content element comprises one or more of, a file, a program, an application, an object, a dynamic link library, a data structure definition, a data structure, a file system definition, a file system, an applet, a servlet, a subroutine, a database record, and a database.

10. The system of claim 1, where the build logic is further configured to store, in the data store, information concerning one or more of, a software image build, and a software image installation.

11. A system, comprising:
a superset configured to store a set of building blocks and data related to members of the set of building blocks, where the superset stores data retrieved from one or more of, a software data store configured to store one or more building blocks that may be included in a software image, an attribute data store configured to store an attribute related to one or more building blocks stored in the software data store, a rules data store configured to store a rule that facilitates controlling one or more of, including building blocks in a software image, preparing building blocks to be included in a software image, and adding building blocks to a software image, and a constraint data store configured to store a constraint that facilitates establishing a scope of the software image; and
a platform specific image generator configured to read a subset of building blocks, attributes, rules, and constraints from the superset, and to build a software image from the subset of building blocks, where the platform specific image generator may be controlled, at least in part, by a rule and a constraint.

12. The system of claim 11, including an image creator configured to store the software image on a computer-readable medium.

13. The system of claim 11, where a building block comprises one or more of, a file, a program, an application, an object, a dynamic link library, a data structure definition, a data structure, a file system definition, a file system, an applet, a servlet, a subroutine, a database record, and a database.

14. The system of claim 11, where an attribute is configured to store information concerning one or more of, an operating system associated with a building block, an operating system version associated with a building block, a spoken language associated with a building block, a computer language associated with a building block, a geographic region in which a building block may function, a device identifier for a device with which a building block may function, a release data associated with a building block, an architecture with which a building block may function, a build list, an interaction between two or more building blocks, a desired interaction between two or more building blocks, and a dependency between two or more building blocks.

15. The system of claim 11, where a rule describes one or more of, how a building block is to be selected for inclusion in a software image, how to combine two or more building blocks, how to connect two or more building blocks, when a building block is to be processed, and how a building block is to be processed.

16. The system of claim 12, the image creator being configured to store the software image on a computer-readable medium that is operably connectable to a target platform for which the software image is made platform specific.

17. The system of claim 16, where the computer-readable medium comprises one or more of, a hard disk drive, a CD, a DVD, a tape, a floppy disk, a Zip disk, an application specific integrated circuit, a memory stick, a memory, and a USB token.

18. A method, comprising:
accessing a data store configured to store a superset of building blocks from which a platform specific software image can be produced;
identifying a subset of building blocks to be included in a software image;
selectively reading members of the subset of building blocks from the superset;
reading, from the superset, one or more attributes concerning members of the subset of building blocks;
reading, from the superset, one or more rules concerning members of the subset of building blocks;
acquiring one or more constraints concerning members of the subset of building blocks;
building a platform specific software image that includes one or more building blocks, where building the platform specific software image is controlled, at least in part, by one or more of, the rule, the attribute, and the constraint; and
controlling an image creator to store the platform specific software image on a computer-readable medium associated with a target platform for which the software image is made platform specific.

19. The method of claim 18, where a building block comprises one or more of, a file, a program, an application, an object, a dynamic link library, a data structure definition, a data structure, a file system definition, a file system, an applet, a servlet, a subroutine, a database record, and a database.

20. The method of claim 18, where an attribute is configured to store information concerning one or more of, an operating system associated with a building block, an operating system version associated with a building block, a spoken language associated with a building block, a computer language associated with a building block, a geographic region in which a building block may function, a device identifier for a device with which a building block may function, a release data associated with a building block, an architecture with which a building block may function, a build list, an interaction between two or more building blocks, a desired interaction between two or more building blocks, and a dependency between two or more building blocks.

21. The method of claim 18, where a rule describes one or more of, how a building block is to be selected for inclusion in a software image, how to combine two or more building blocks, how to connect two or more building blocks, when a building block is to be processed, and how a building block is to be processed.

22. The method of claim 18, where a constraint describes one or more of, how to limit the operation of a building block, and when to exclude a building block from a software image.

23. A computer-readable medium storing processor executable instructions operable to perform a method, the method comprising:
accessing a data store configured to store a superset of building blocks from which a platform specific software image can be produced, where a building block comprises one or more of, a file, a program, an application, an object, a dynamic link library, a data structure definition, a data structure, a file system definition, a file system, an applet, a servlet, a subroutine, a database record, and a database;
identifying a subset of building blocks to be included in a software image;
selectively reading members of the subset of building blocks from the superset;
reading, from the superset, one or more attributes concerning the members of the subset of building blocks, where an attribute is configured to store information concerning one or more of, an operating system associated with a building block, an operating system version associated with a building block, a spoken language associated with a building block, a computer language associated with a building block, a geographic region in which a building block may function, a device identifier for a device with which a building block may function, a release data associated with a building block, an architecture with which a building block may function, a build list, an interaction between two or more building blocks, a desired interaction between two or more building blocks, and a dependency between two or more building blocks;
reading, from the superset, one or more rules concerning how to process members of the subset of building blocks into the software image, where a rule describes one or more of, how a building block is to be selected for inclusion in a software image, how to combine two or more building blocks, how to connect two or more building blocks, when a building block is to be processed, and how a building block is to be processed;
acquiring one or more constraints concerning how members of the subset of building blocks are to be limited in the software image, where a constraint describes one or more of, how to limit the operation of a building block, and when to exclude a building block from a software image;
building a platform specific software image that includes one or more building blocks; and
controlling an image creator to store the platform specific software image on a computer-readable medium associated with the target platform for which the software image is being made platform specific.

24. A method for producing a platform specific software image and installing the platform specific software image on a computer-readable medium that is operably connectable to a target platform for which the software image is made platform specific, comprising:
receiving a first data that identifies one or more of, an operating system to be employed on the target platform, a language spoken by a user of the target platform, a region of the world in which the target platform will be used, and a target platform usage;
receiving a hardware discovery data that identifies a hardware component associated with the target platform;
receiving a second data concerning a partitioning choice for the computer-readable medium associated with the target platform;
receiving a third data concerning a software component choice;
building a software bill of materials based, at least in part, on one or more of, the first data, the hardware discovery data, the second data, and the third data, where the software bill of materials identifies one or more building blocks to be included in the software image;
acquiring one or more building blocks listed in the software bill of materials from a superset of building blocks;
producing the software image from the one or more building blocks; and
storing the software image on the computer-readable medium.

25. The method of claim 24, including producing a query for retrieving a building block from the superset of building blocks based, at least in part, on the first data.

26. The method of claim 24, where the hardware discovery data identifies one or more of, a hardware component associated with the target platform, a software component associated with the target platform, and a firmware component associated with the target platform.

27. The method of claim 26, including producing a query for retrieving a building block from the superset of building blocks based, at least in part, on the hardware discovery data.

28. The method of claim 24, where a building block listed in the software bill of materials may be acquired from the superset of building blocks in response to a query that is based on one or more of, the first data, the hardware discovery data, the second data, and the third data being presented to the superset of building blocks.

29. A system, comprising:
means for acquiring a set of building blocks from which a customized software image can be built;
means for building the customized software image from the set of building blocks; and
means for storing the customized software image on a computer-readable medium.

30. In a computer system having a graphical user interface comprising a display and a selection device, a method of providing and selecting from a set of data entries on the display, the method comprising:
retrieving a set of data entries, where a data entry represents a software image build operation;
displaying the set of data entries on the display;
receiving a data entry selection signal indicative of the selection device selecting a selected data entry; and
in response to the data entry selection signal, initiating a software image build operation associated with the selected data entry.

31. A set of application programming interfaces embodied on a computer-readable medium for execution by a logic in conjunction with building a platform specific software image from a superset of building blocks, comprising:
a first interface for communicating a building block that may be included in the platform specific software image;
a second interface for communicating an attribute data concerning a building block; and
a third interface for communicating a rule concerning how to process a building block into the platform specific software image.
